(19) United States
(12) Patent Application Publication
(10) Pub. No.: US 2015/0189858 A1
(43) Pub. Date: Jul. 9, 2015

(54) Stool Pouch for Dog

(71) Applicant: Sun Hwa KIM, Los Angeles, CA (US)

(72) Inventor: Sun Hwa KIM, Los Angeles, CA (US)

(21) Appl. No.: 14/150,486

(22) Filed: Jan. 8, 2014

(51) Int. Cl. A01K 23/00

(52) U.S. Cl. CPC A01K 23/00

(57) ABSTRACT

A stool pouch for a dog comprises a sac, two leg holes, a tail hole, and two tying straps. The sac is configured for receiving and collecting dog stool dropped from above. The two leg holes are provided through an upper portion of the front portion of the sac and configured for receiving dog hindlegs and queuing the dog hindlegs therethrough respectively. The tail hole is provided through the rear portion of the sac. Each of the two tying straps extends from a corresponding edge portion of the opening portion of the sac, configured for tying over a rear portion of dog waist so as to fix the stool pouch in place. The two leg holes are disposed apart by an interval substantially same as a distance between two upper portions of the dog hindlegs.

### BACKGROUND OF THE INVENTION

The present invention relates to a stool pouch for dog. More particularly, this invention relates to a stool pouch for dog, which facilitates handling of dog stools.

For the purpose, many kinds of dog diapers had been suggested, for example, U.S. Pat. No. 5,555,847. But, the performances were not satisfying always.

Accordingly, a need for a stool pouch for dog has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a stool pouch for dog.

An aspect of the invention provides a stool pouch for a dog.

The stool pouch comprises a sac, two leg holes, a tail hole, and two tying straps.

The sac comprises an opening portion, a closed end portion, a front portion, and a rear portion, and configured for receiving and collecting dog stool dropped from above.

The two leg holes are provided through an upper portion of the front portion of the sac and configured for receiving dog hindlegs and queuing the dog hindlegs therethrough respectively.

The tail hole is provided through the rear portion of the sac and configured for receiving a dog tail and queuing the dog tail therethrough.

Each of the two tying straps extends from a corresponding edge portion of the opening portion of the sac, configured for tying over a rear portion of dog waist so as to fix the stool pouch in place.

The two leg holes are disposed apart by an interval substantially same as a distance between two upper portions of the dog hindlegs.

The position of the tail hole may be adjusted so that a edge side line makes an angle between about 30 degrees and about 90 degrees.

The sizes of the two leg holes and the tail hole may be determined by sizes of the dog.

The sac and the two tying straps may be formed integrally.

The sac and the two tying straps may be made of flexible sheet material.

The flexible sheet material may comprise plastic and organic polymers.

The sac may have a substantially cylindrical shape.

The sac may have a substantially rectangularly folded shape having a bottom edge and two side edges.

The front portion of the sac may be shorter than the rear portion of the sac by a predetermined length.

Each of the tying straps may extend from a corresponding first point between the front and rear portions of the sac.

Each of the tying straps may extend from a corresponding second point on the front portion of the sac.

Each of the tying straps may extend from a corresponding third point on the rear portion of the sac.

Each of the two tying straps may comprise a tying end.

Each of the two tying straps may further comprise a fastener disposed at the tying end.

The fastener may comprise a hook and loop fastener.

The advantages of the present invention are: (1) the stool pouch enables a convenient handling of dog stool; and (2) the stool pouch is simple and cheap in manufacturing and using thereof.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a stool pouch put on by a dog according to an embodiment of the invention;

FIG. 2 is a front perspective view showing a stool pouch put on by a dog according to another embodiment of the invention;

FIG. 3 is a rear perspective view showing the stool pouch of FIG. 2;

FIG. 4 is a rear perspective view showing a stool pouch according to still another embodiment of the invention;

FIG. 5 is a side perspective view showing a stool pouch according to still another embodiment of the invention;

FIG. 6 is a front perspective view showing a stool pouch put on by a dog according to still another embodiment of the invention; and

FIG. 7 is a rear perspective view showing a stool pouch according to still another embodiment of the invention.

### DETAILED DESCRIPTION EMBODIMENTS OF THE INVENTION

An aspect of the invention provides a stool pouch 100 for a dog 90.

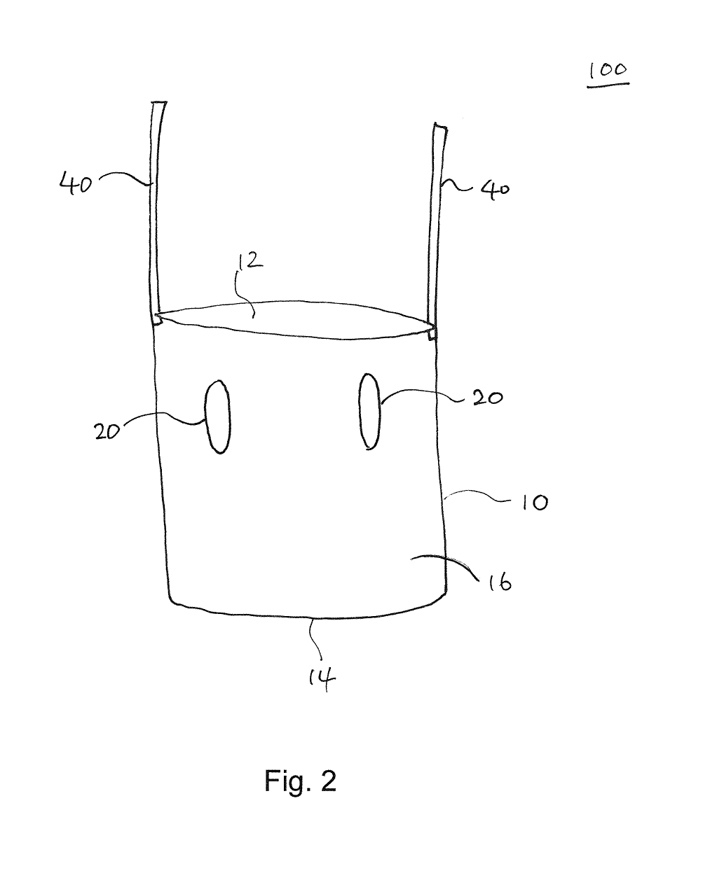

The stool pouch 100 comprises a sac 10, two leg holes 20, a tail hole 30, and two tying straps 40 as shown in FIGS. 2-5.

The sac 10 comprises an opening portion 12, a closed end portion 14, a front portion 16, and a rear portion 18, and configured for receiving and collecting dog stool dropped from above.

The two leg holes 20 are provided through an upper portion of the front portion 16 of the sac 10 and configured for receiving dog hindlegs and queuing the dog hindlegs therethrough respectively.

The tail hole 30 is provided through the rear portion 18 of the sac 10 and configured for receiving a dog tail and queuing the dog tail therethrough.

Each of the two tying straps 40 extends from a corresponding edge portion of the opening portion 12 of the sac 10, configured for tying over a rear portion of dog waist so as to fix the stool pouch 100 in place.

The two leg holes 20 are disposed apart by an interval substantially same as a distance between two upper portions of the dog hindlegs. However, this is not limiting. Since the sac is flexible enough, the interval may be larger than the dimension of the dog 90.

The position of the tail hole 30 may be adjusted so that a edge side line makes an angle between about 30 degrees and about 90 degrees.

The sizes of the two leg holes 20 and the tail hole 30 may be determined by sizes of the dog 90.

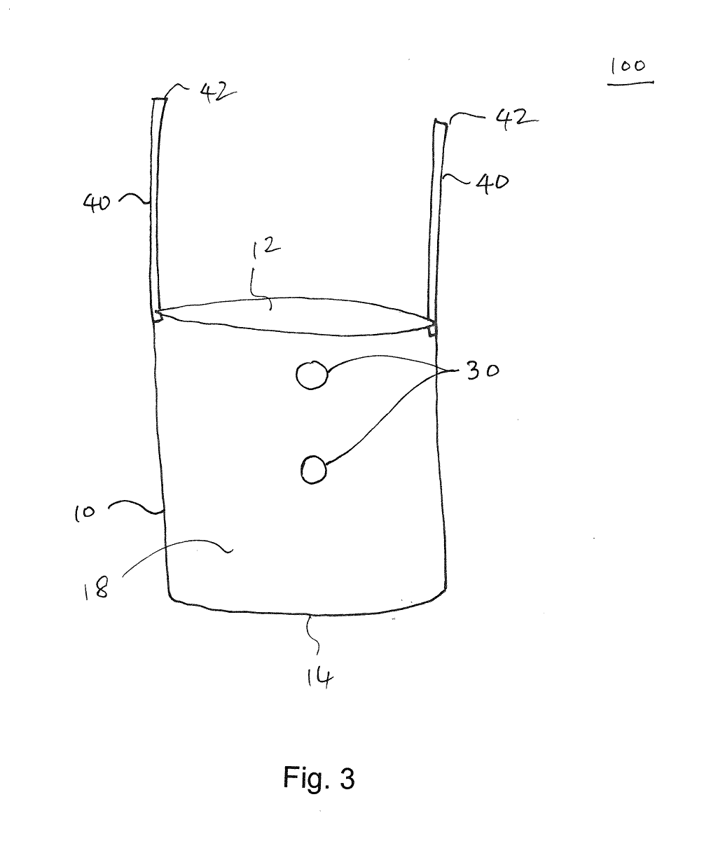

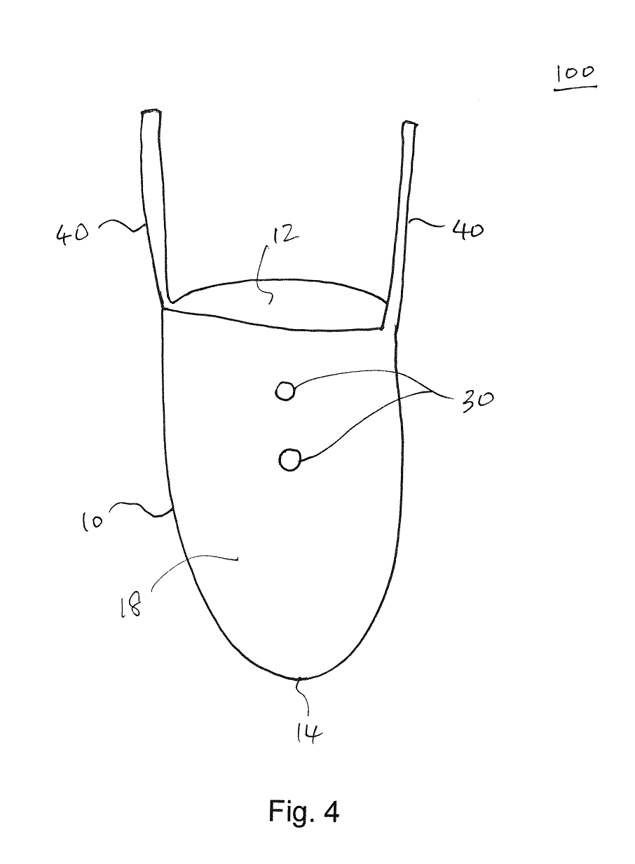

Also, the stool pouch 100 may comprise one or more holes as shown in FIGS. 3 and 4. The top hole may be used for stool while the bottom hole for pee, for example, for a same dog. Or, the top hole may be used for a big dog while the bottom hole for a small dog.

The sac 10 and the two tying straps 40 may be formed integrally.

The sac 10 and the two tying straps 40 may be made of flexible sheet material.

The flexible sheet material may comprise plastic and organic polymers.

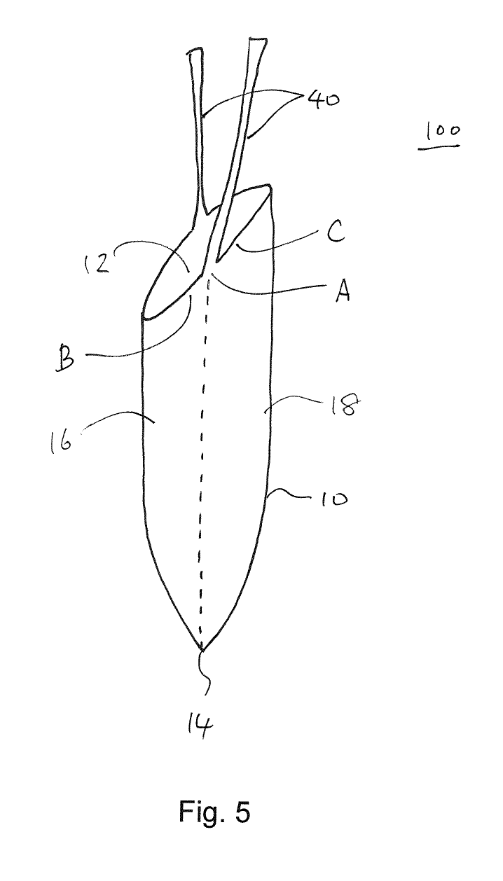

The sac 10 may have a substantially cylindrical shape as shown in FIGS. 4 and 5.

The sac 10 may have a substantially rectangularly folded shape having a bottom edge and two side edges as shown in FIGS. 2 and 3.

The front portion 16 of the sac 10 may be shorter than the rear portion 18 of the sac 10 by a predetermined length as shown in FIG. 5. This can help to fit the stool pouch 100 more snugly to the dog 90.

Each of the tying straps 40 may extend from a corresponding first point A between the front and rear portions 16, 18 of the sac 10 as shown in FIGS. 2-5.

Each of the tying straps 40 may extend from a corresponding second point B on the front portion 16 of the sac 10 as shown in FIG. 5.

Each of the tying straps 40 may extend from a corresponding third point C on the rear portion 18 of the sac 10 as shown in FIG. 5.

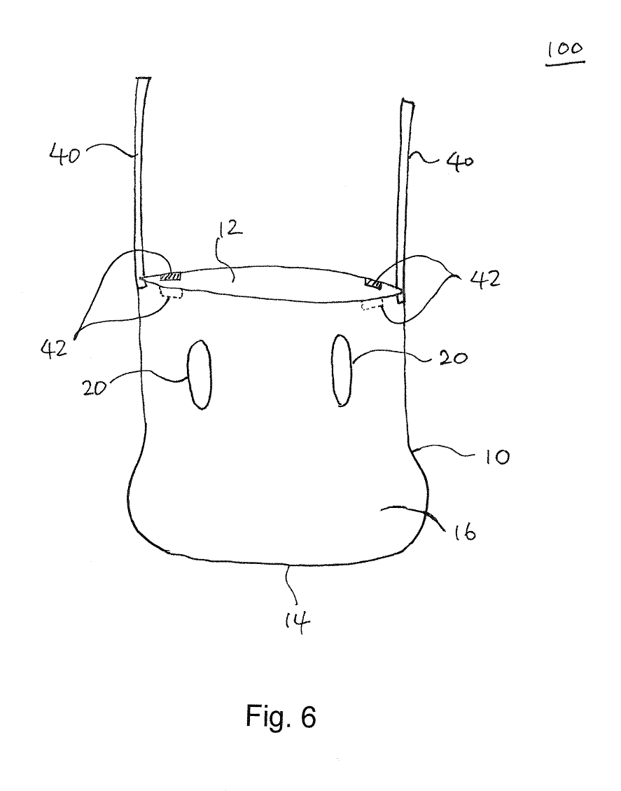

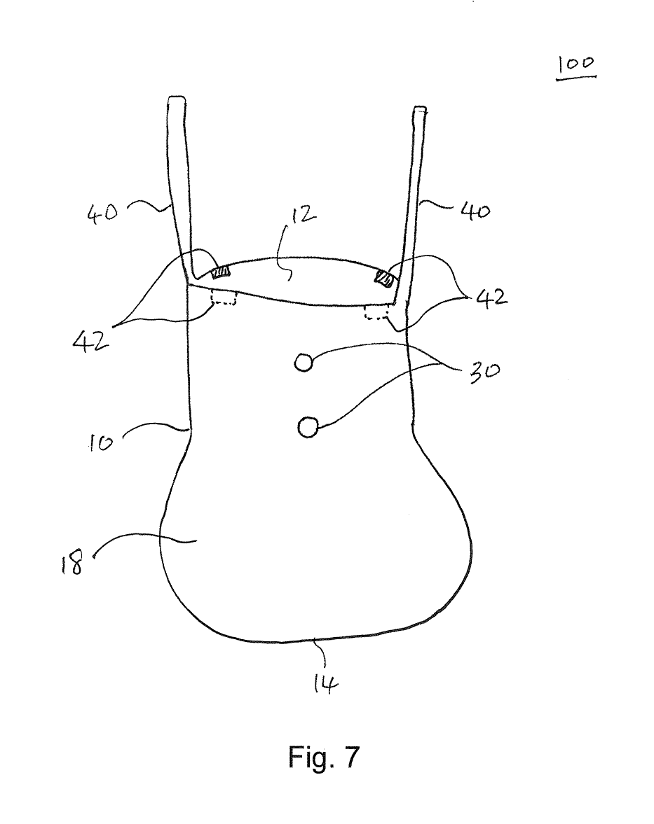

In certain embodiments, the sac 10 may have a bulged lower portion as shown in FIGS. 6 and 7. That way, the sac 10 may look better when put on by the dog.

Also, the stool pouch 100 may further comprise one or more hook and loop fasteners 42 as shown in FIGS. 6 and 7, such that the waist of the dog can be tightened further.

Each of the two tying straps 40 may further comprise a fastener disposed at the tying end 42. The fastener may comprise a hook and loop fastener as shown in FIG. 4.

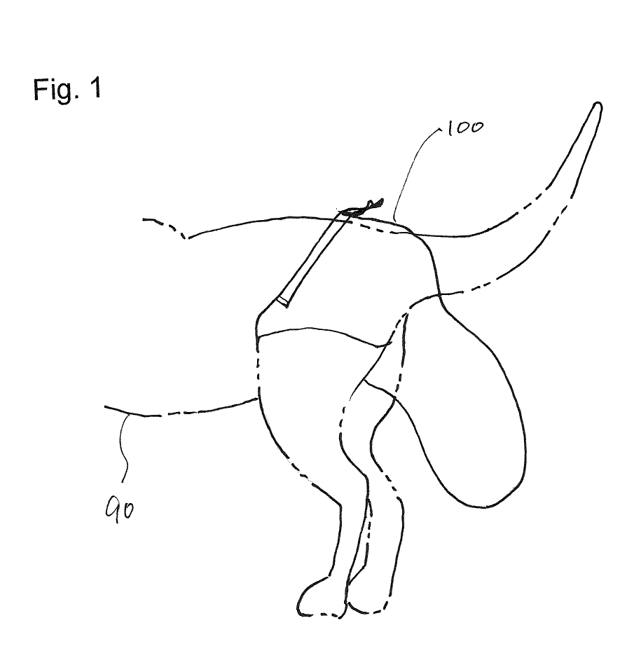

With the stool pouch 100 on as in FIG. 1, the dog 90 may be maintained clean and nice because stools or pees can be collected in the sac 100.

Overall, the sac 10 is not very different from a grocery bag. And there are three or more holes in addition. That means that it is very cheap and easy to manufacture the stool pouch 100.

Also, the stool pouch 100 according to the invention may be appealing in look. The sac 10 may have some colors or pattern on the outer surface in order to beautify the stool pouch 100.

Since the stool pouch 100 is very light and flexible, the dog 90 may be able to ignore the presence thereof.

Also, the stool pouch 100 can be used for dogs of different sizes. By adjusting the positions of the holes 20 and 30, the dog size can be accommodated very conveniently.

The stool pouch 100 cannot be put off easily by the dog 90 because it cannot be reached by the dog 90.

By selecting the right tail hole 30, the stool pouch 100 can be made more adapted for stools or pees.

A partial portion of the sac 10 may be made transparent, for example, around the tail hole 30 or at the lower end 14. Through the transparent window, the state of the stool pouch 100 can be checked visually very easily.

The length of the tying straps 40 can be made long or short according to the size of dog.

Since the sac 10 is almost sealed once worn by the dog 90, the stool pouch 100 can be like a blown balloon, which makes the dog very cute.

In certain embodiments, the sac 10 may have two folding lines with a given interval on each of the two sides, which may facilitate forming a swollen shape when put on by the dog. Just one folding line is shown as a dashed in FIG. 5. Two folding lines can be imagined easily.

Each of the tying straps 40 may have a width of 1 and a half inches, which helps to tie and untie them. The length of the tying straps 40 may be as long as the sac 10 or longer.

The tying straps 40 may be attached to the top edge of the sac 10 substantially in parallel to the top edge of the sac 10. That is, in FIG. 5, the tying straps 40 may be provided to be tilted more.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A stool pouch for a dog, the stool pouch comprising:
a sac comprising an opening portion, a closed end portion, a front portion, and a rear portion, and configured for receiving and collecting dog stool dropped from above;
two leg holes provided through an upper portion of the front portion of the sac and configured for receiving dog hindlegs and queuing the dog hindlegs therethrough respectively;
a tail hole provided through the rear portion of the sac and configured for receiving a dog tail and queuing the dog tail therethrough; and
two tying straps, each of which extending from a corresponding edge portion of the opening portion of the sac, configured for tying over a rear portion of dog waist so as to fix the stool pouch in place,
wherein the two leg holes are disposed apart by an interval substantially same as a distance between two upper portions of the dog hindlegs.

2. The stool pouch of claim 1, wherein a position of the tail hole is adjusted so that a edge side line makes an angle between about 30 degrees and about 90 degrees.

3. The stool pouch of claim 2, wherein sizes of the two leg holes and the tail hole are determined by sizes of the dog.

4. The stool pouch of claim 1, wherein the sac and the two tying straps are formed integrally.

5. The stool pouch of claim 4, wherein the sac and the two tying straps are made of flexible sheet material.

6. The stool pouch of claim 5, wherein the flexible sheet material comprises plastic and organic polymers.

7. The stool pouch of claim 1, wherein the sac has a substantially cylindrical shape.

8. The stool pouch of claim 1, wherein the sac has a substantially rectangularly folded shape having a bottom edge and two side edges.

9. The stool pouch of claim 8, wherein the front portion of the sac is shorter than the rear portion of the sac by a predetermined length.

10. The stool pouch of claim 1, wherein each of the tying straps extends from a corresponding first point between the front and rear portions of the sac.

11. The stool pouch of claim 1, wherein each of the tying straps extends from a corresponding second point on the front portion of the sac.

12. The stool pouch of claim 1, wherein each of the tying straps extends from a corresponding third point on the rear portion of the sac.

13. The stool pouch of claim 1, wherein each of the two tying straps comprises a tying end.

14. The stool pouch of claim 13, wherein each of the two tying straps further comprises a fastener disposed at the tying end.

15. The stool pouch of claim 13, wherein the fastener comprises a hook and loop fastener.

16. The stool pouch of claim 1, wherein the sac has a bulged lower portion.

17. The stool pouch of claim 1, wherein the sac has two or more folding lines along side portions.

18. The stool pouch of claim 1, wherein each of the two tying straps is attached a top edge of the sac substantially in parallel to the top edge.
